(19) United States
(12) Patent Application Publication
(10) Pub. No.: US 2003/0089569 A1
(43) Pub. Date: May 15, 2003

(54) Trasmission devices, for ground vehicles and more particularly for molor-cars

(76) Inventors: Roumen Antonov, Paris (FR); Frederic Morant, La Plaine D'Avancon (FR)

Correspondence Address: KENYON & KENYON, ONE BROADWAY, NEW YORK, NY, 10004, US

(21) Appl. No.: 10/257,527

(22) PCT Filed: Nov. 15, 2001
(86) PCT No.: PCT/EP01/13398

(51) Int. Cl. F16D 47/00

(52) U.S. Cl. 192/48.92; 192/48.3; 192/48.9

(57) ABSTRACT

The epicyclic train is able to operate as a speed reducing gear when sun-wheel (5) is stuck by a one-way clutch (8), and in direct drive when clutch (10) is engaged. The whole coupling and control structure for the ratio change is essentially grouped on the sun-wheel element (5) which is slidingly movable and integral with an inverter control means (111) which engages brake (9) when disengaging clutch (10), and conversely. The brake (9) is mounted mechanically in parallel with a one way clutch (8), and allows speed reducing operation when the torque applied to the input shaft (31) is a retarding torque. The one-way clutch is mounted in parallel with an axially unslidable bearing (54) between a stator shaft (21) and a support (51) coupled for common rotation with and mutual slidability with respect to the sun-wheel element (5). For actuation of the control member (111) there is provide an hydraulic actuator (116), spring (114), and involvement of the helical teeth axial thrust (F1, F2). Useful for simplifying the control, keeping a possibility of other selective couplings, allowing other operating conditions, with the other rotary elements (6, 7) of the train, and avoiding the thrust bearings.

### DESCRIPTION

This invention relates to transmission devices for ground vehicles and more particularly for motor-cars.

The invention more specifically relates to transmission devices capable of automation and/or capable of providing numerous transmission ratios with a relatively simple structure.

Almost all the automatic transmission devices make use of differential mechanisms and more particularly epicyclic trains in which selective coupling means such as brakes, clutches and/or one-way clutches allow to change the transmission ratio provided by each elementary train. Conventionally, an epicyclic train provides one or the other of two ratios, one of the ratios being a direct drive obtained by means of a clutch which binds together two intermeshed rotary elements of the train. Epicyclic trains providing more than two ratios are known but they generally consist of so-called “complex” epicyclic trains, that is to say epicyclic trains having more than three intermeshed rotary elements and which are in fact equivalent to at least two elementary epicyclic trains.

As a result of the current demand for automatic transmissions offering a great number of different transmission ratios, e.g. five or even six, it becomes usual to design automatic transmissions comprising four or even five epicyclic trains. Such transmission devices are heavy, expensive, cumbersome, and poorly efficient in terms of energetic efficiency.

Furthermore, the numerous epicyclic trains result in a particularly complicated and expensive automatic control.

EP-A-0 683 877 discloses automatic transmission devices in which the automatic control is made simpler thanks to exploitation of the axial thrust of helical teeth, at the same time as a measurement of the transmitted torque and as an actuating force which is proportional to this torque. This force maintains in the disengaged condition a direct-drive clutch mounted between the input element and the output element of the epicyclic train when the epicyclic train operates as a speed reducing gear. Simultaneously, the third element of the train is maintained stationary by a one-way clutch (free-wheel) when the engine torque is motive and by an auxiliary brake subjected to an hydraulic actuation when the engine torque is reversed (engine-brake operation). The engagement of the direct-drive clutch takes place under the effect of centrifugal fly-weights when the rotational speed is high enough for allowing such fly-weights to overcome the axial tooth thrust. The hydraulic actuating force is also used for influencing the automatic behaviour of the transmission, that is to say for altering the “natural” balance between the tooth thrust and the centrifugal actuating force.

With this known device, the control is admittedly less complicated and energy-wasting but again a simple epicyclic train provide only two ratios. Furthermore, numerous thrust bearings are necessary, which are a cause of noise and wear.

The axial displacements need splines operating under load, which have a tendency to “pollute” the torque and speed signals provided by the tooth thrust and by the centrifugal fly-weights respectively.

The change-over of the known epicyclic train between one and the other of its two transmission ratios concerns all the components of the train and needs a relatively complicated synchronisation between actuating members. Although an epicyclic train is theoretically able to provide relatively numerous transmission ratios, it has not been practically possible to provide more than two, taking into account the complicated shifting process from one to the other of the two ratios.

An object of this invention is to provide a transmission device wherein the means necessary for shifting from one ratio to the other in a differential mechanism are remarkably simplified.

Another object of this invention is to provide a transmission device in which a simple differential mechanism, that is to say with only three intermeshed elements, is capable of providing more than two transmission ratios.

A further object of the present invention is to provide a transmission device allowing to provide numerous ratios with a remarkably simple structure and an enhanced mechanical efficiency.

According to a first aspect of the invention, a transmission device wherein a differential mechanism comprises:

a casing element;

an input rotary connection element and an output rotary connection element;

three rotary elements which are rotatable with respect to the casing element and mutually intermeshed;

two friction coupling means between said elements;

a one-way clutch forbidding one direction of relative rotation of a first one of the rotary elements with respect to a second one of said elements;

actuating means for said coupling means;

is characterized in that

a first one of said selective coupling means is mechanically in parallel with the one-way clutch;

a second one of said selective coupling means is mounted operatively between said first element and a third one of said elements;

said two friction coupling means are coordinated by an inverter control means between two stable states in each of which one of the coupling means is engaged and the other is released, respectively.

With this device, the first rotary element of the differential mechanism is involved in all the coupling changes which are necessary for changing the transmission ratio. The first rotary element is

i) either made fast with the second element (e.g. the casing) by the first selective coupling means and, for one of the torque direction, by the one-way clutch mounted in parallel with this first coupling means,

ii) or made fast with the third element (e.g. one of the rotary connection elements and, in a still more precise example, the input rotary connection element) by the second selective coupling means.

The other elements constituting the transmission device are thus rendered much more simpler. The friction coupling means can be spatially grouped close to each other in a particularly advantageous manner. The actuating means are simpler because each friction coupling means has a part which is fast with the first rotary element and it is therefore no longer necessary to transmit forces between elements rotating at different speeds. The inverter control means, which is typically connected for common rotation with the first rotary element may, between its two stable conditions, move through a floating position where the two friction coupling means are both disengaged. This is not a drawback because the one-way clutch simultaneously realises the situation corresponding to engagement of the first selective coupling means. To this end, the one-way clutch is mounted in parallel with the coupling means which is engaged for the operation providing the lower of the two transmission ratios, and the direction forbidden by the one-way clutch is that which would produce a still lower transmission ratio.

It is particularly advantageous to cause the first rotary element of the differential mechanism to be integral with the inverter control means and to contribute to actuation of the inverter control means by way of the tooth thrust, the teeth being made helical.

In this manner, the structure is simple and reliable and the tooth thrust is transmitted to the inverter control means without alteration. The inverter control means is preferably implemented as a simple pressure member having two opposed faces each of which is capable of tightening a respective one of the first and second friction coupling means.

As a rule, one-way clutches available in the commerce do not allow relative axial displacement. To enable the first rotary element to move axially despite provision of the one-way clutch between said first and second element, there is a preferably provided mechanically in series with the one-way clutch between the first rotary element and the second element, a means for common rotation and axial displaceability.

This coupling for common rotation is preferably mounted operatively between one of the first and second elements and a one-way clutch support. There is provided mechanically in parallel with the one-way clutch, an axially unslidable bearing between the one-way clutch support and the other of said first and second elements. Thus, the one-way clutch is perfectly protected from any axial stress.

On the other hand, for avoiding abnormal friction in the means for common rotation with axial slidability, it is preferred that the first rotary element is guided for axial sliding independently of the means for common rotation with axial displaceability.

The means for common rotation may be mounted between the first element and the one-way clutch support. The support therefore rotates at the same speed as the first rotary element while being made axially fast with the second element which is typically the casing element. The support is then adapted to bear another actuating means, such as a spring, which can thus axially urge the first rotary element without any need of interposing any axial thrust bearing.

A still further actuating means can consist of an hydraulic pushing element which is attached to the first rotary element, is coaxial therewith and can simultaneously contribute to the slidable guiding of the first rotary element. Consequently, all the actuations which are necessary for the ratio-changes may be performed solely by displacement of the first rotary element and of the inverter control means which is attached thereto, under multiple control forces and without transmission of the control forces through axial thrust bearings.

For selection between two transmission ratios in an epicyclic train, there has just been described an elementary structure for coupling and control which is essentially grouped together onto one of the rotary elements of the differential mechanism. The invention also encompasses provision of another such elementary structure onto another one of the rotary elements of the differential mechanism. The third rotary element of the differential mechanism may for example be permanently connected to one of the input and output rotary connection elements, e.g. the output element. There is thus provided an epicyclic train capable of four different operating conditions.

If a same rotary connection element, e.g. the input element, is managed to be associated with the two friction coupling means which are not in parallel with a one-way clutch, one of the four operating conditions corresponding to the case where the above-mentioned two friction coupling means are disengaged is a neutral condition which is useful e.g. for allowing the vehicle to remain stationary while the engine shaft of the vehicle rotates. If the two other selective coupling means are brakes blocking the differential mechanism and, therewith, the output connection element, a pa-king brake function is simultaneously fulfilled. For shifting from this neutral condition to one of the three other conditions corresponding to a transmission ratio, it is merely necessary to change condition of one of both inverter control means and this can be made with a progressivity which is high enough to ensure progressive starting of the vehicle. There is thus provided with a sole simple epicyclic train a transmission device offering at the same time three transmission ratios, one neutral condition and a progressive starting device capable of allowing to dispense with the clutch or torque converter which is conventionally provided between the engine and the transmission device in a motor car.

According to another aspect of the invention, it is possible to use in the transmission device two differential mechanisms which are controlled in the just described manner. One of the conditions of one of the differential mechanisms may be a reverse run ratio. Preferably, the reverse run ratio is provided in the differential mechanism which is located further downstream.

Even with a single simple differential mechanism, it is possible, as will be seen, to provide a several-ratios forward drive and a reverse drive.

According to a further aspect of this invention, there is provided a transmission device wherein a transmission mechanism comprises

an input rotary connection element and an output rotary connection element;

at least two rotary elements which are rotatable with respect to the casing element and are, at least indirectly, mutually intermeshed;

at least one friction coupling means capable of providing a neutral condition in the transmission mechanism when disengaged, and a power transmission relationship between said two connection elements in the engaged condition;

actuating means for actuating the friction coupling means, said actuating means comprising:

a) two antagonistic actuating means, at least one of said two antagonistic actuating means being controllable;

b) an axial movability of at least one of said two intermeshed rotary elements, and transmission means for transmitting an axial tooth thrust of said intermeshed rotary element to a pressure member of the friction coupling means.

This aspect of the invention provides a possibility of dispensing with the conventional input clutch or input torque converter. A friction coupling means provided in the transmission mechanism is operable for providing a neutral condition in which the power transmission flow path from the prime mover to the load to be driven e.g. the wheels of a vehicle, is interrupted within the transmission mechanism.

Furthermore, the axial tooth thrust created by the gear teeth in the transmission is used as an actuating force for the friction coupling means. If the tooth thrust is in a direction corresponding to engagement of the friction coupling means, the result is a reduction of the additional force which is necessary for engaging the friction coupling means. Typically, this additional force is produced by the controllable actuator, such as a hydraulic actuator. Disengagement of the clutch can be performed by a spring which is strong enough to counteract the tooth pressure when the controllable actuator is de-energized. Such a device is able to perform progressive start of the vehicle when the transmission device is initially in the neutral condition while the vehicle engine has being previously started. The controllable actuator is controllably energized for performing progressive, smooth start of the vehicle. A regulation can be provided for avoiding any shocks. For example, the acceleration of the vehicle may be detected, and compared to a desired value. The result of this comparison is the basis of an adjustment of the level of energization of the controllable actuator and/or of the power and/or r.p.m. of the engine.

It is also possible to arrange the transmission mechanism so that the direction of the tooth thrust is contrary to the direction of the force produced by the controllable actuator. The starting function is then to some extent self-regulated because an excessively high acceleration of the vehicle produces an increase of the tooth pressure, this increase tending in turn to somewhat disengage the clutch, i.e. reduce the grip in the clutch. The drawback of this solution is that the force to be produced by the actuator for engaging the friction coupling means is high because it has to overcome the tooth thrust and furthermore to engage the clutch.

According to a still further aspect of this invention, there is provided transmission device wherein a transmission mechanism comprises

an input rotary connection element and an output rotary connection element;

at least two rotary elements which are rotatable with respect to the casing element and are, at least indirectly, mutually intermeshed;

at least two friction coupling means, each of which is capable of providing, when in an engaged condition, a respective power transmission relationship between said two connection elements, with a respective transmission ratio;

antagonistic actuating means for actuating the friction coupling means, said actuating means comprising at east one controllable antagonistic actuating means:

wherein a neutral condition is realised in the transmission mechanism when the two friction coupling means are both in a disengaged condition.

The two friction coupling means allow to select one or the other of two transmission ratios. When the two friction coupling means are both disengaged, a neutral condition is realized in the transmission mechanism, allowing the engine of the vehicle to rotate without any corresponding rotation of the drive wheels of the vehicle. A remarkably simple structure is provided for selecting between three operating conditions.

Preferably, a fourth condition is available, with the two friction coupling means being both engaged. Such a fourth condition is in most cases a direct drive condition.

According to a still further aspect of the invention, there is provided a transmission device wherein a differential mechanism comprises:

a casing element

an input rotary connection element and an output rotary connection element;

two coaxial toothed elements which are rotatable with respect to the casing element and comprise:

a sun wheel; and

a crown-wheel;

a planet-carrier element supporting planets meshing with the sun-wheel and the crown-wheel;

connection means between the planet-carrier and the output rotary connection element;

selective coupling means between the coaxial toothed elements, the casing element and the input connection element;

characterized by said selective coupling means comprising:

a first grouped structure for selectively coupling the sun-wheel with the input connection element and with the casing element;

a second grouped structure for selectively coupling the crown wheel with the input connection element and with the casing element,

thereby to provide:

a low ratio when the sun-wheel is connected to the input connection element and the crown-wheel is connected to the casing element;

an intermediate ratio when the sun-wheel is connected to the casing element and the crown-wheel is connected to the input connection element;

a direct drive ratio when the sun-wheel and the crown-wheel are both connected to the input connection element.

A remarkably simple structure is provided for a three speed transmission mechanism with a number of toothed wheels which may be as low as three.

With almost no supplemental complexity a neutral condition is furthermore provided when both modules disconnect the input connection element from the sun wheel and from the crown wheel respectively.

According to a still further aspect of this invention, there is provided a transmission device comprising:

a three-speed mechanism providing a low ratio, an intermediate ratio and an upper ratio, with a first ratio-gap between the low ratio and the intermediate ratio being at least about the square of a second ratio-gap between the intermediate ratio and the upper ratio;

a two-speed mechanism mounted in series with the three-speed mechanism and providing a lower and a higher ratio, with a third ratio-gap therebetween which is intermediate between said first and said second ratio-gap,

wherein six gears are provided by the following combinations:

first gear: low ratio and lower ratio;

second gear: low ratio and higher ratio;

third gear: intermediate ratio and lower ratio;

fourth gear: upper ratio and lower ratio;

fifth gear: intermediate ratio and higher ratio;

sixth gear: high ratio and higher ratio.

Such a six-speed mechanism with the described ratio-gaps distribution may be of the type defined in the preceding aspect of the invention.

Other features and advantages of the invention will appear from the following description, relating to non limiting examples.

In the attached drawings:

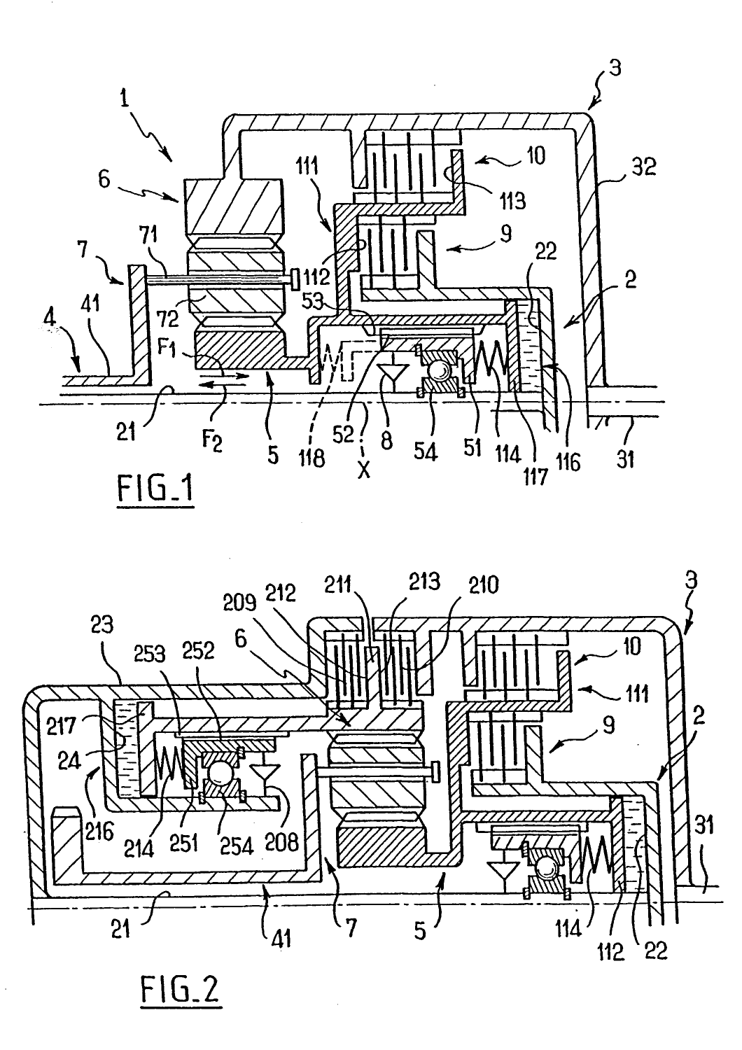

FIGS. 1 and 2 are diagrammatic views, in axial cross-section, corresponding to a first and a second embodiments of a transmission device according to the invention;

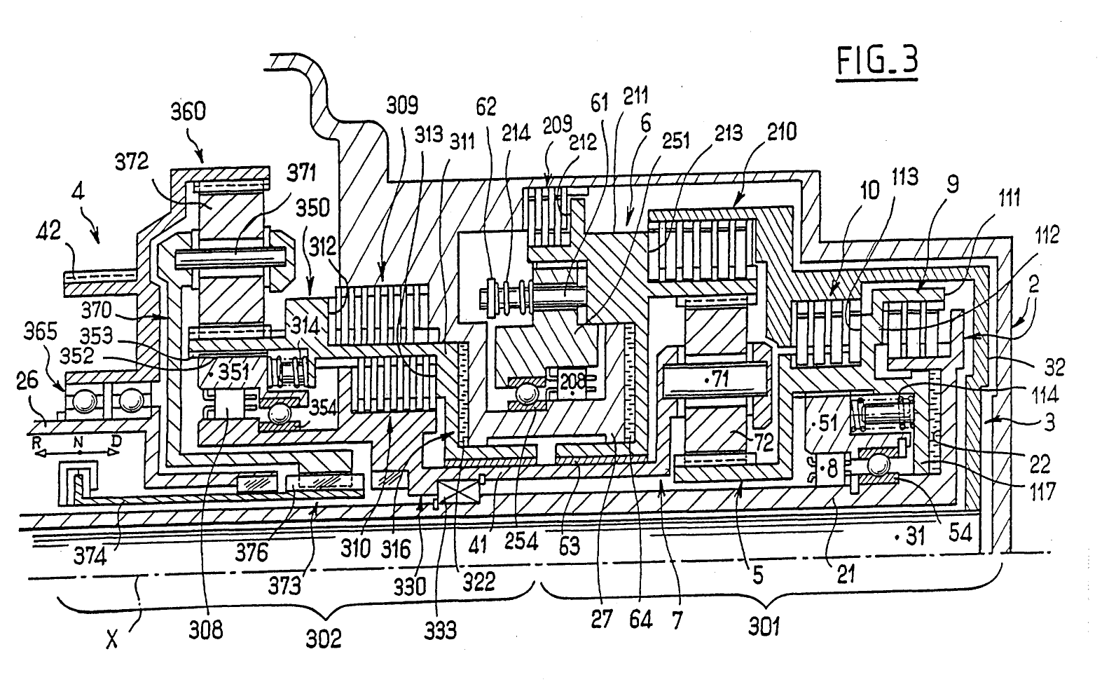

FIG. 3 is a somewhat more detailed half-view, in axial cross-section, of a third embodiment of the transmission device according to the invention;

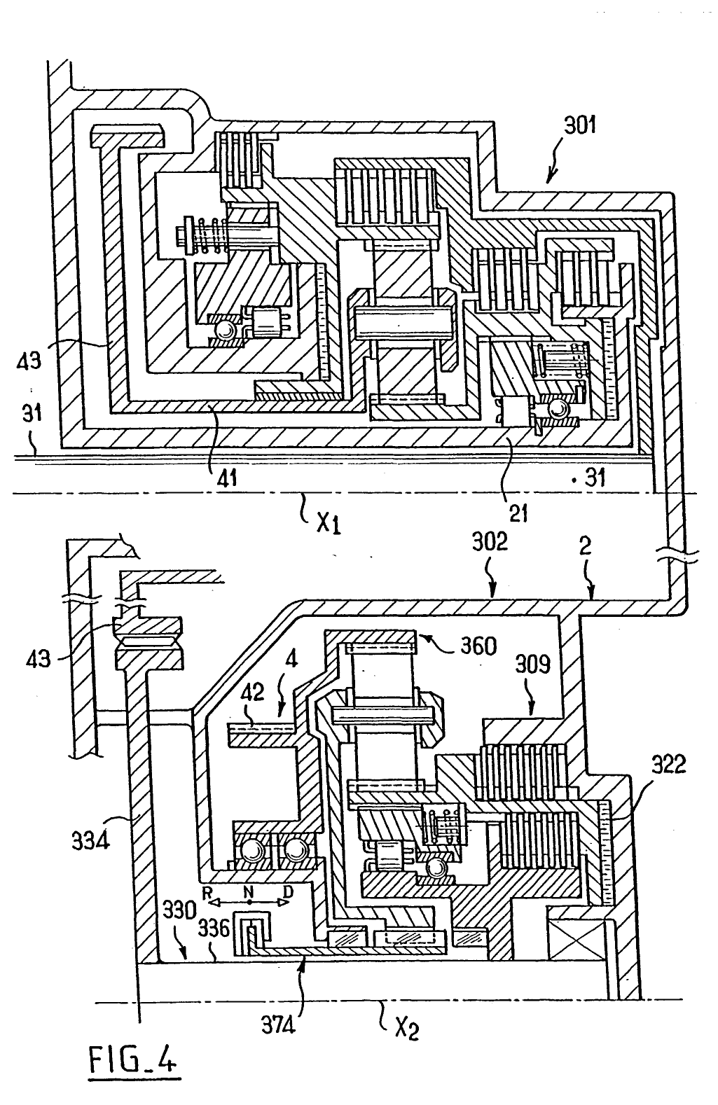

FIG. 4 is a sectional view made along both parallel axes of a transmission device according to the invention, in the form of half-views with respect to each axis, and with broken-away portion;

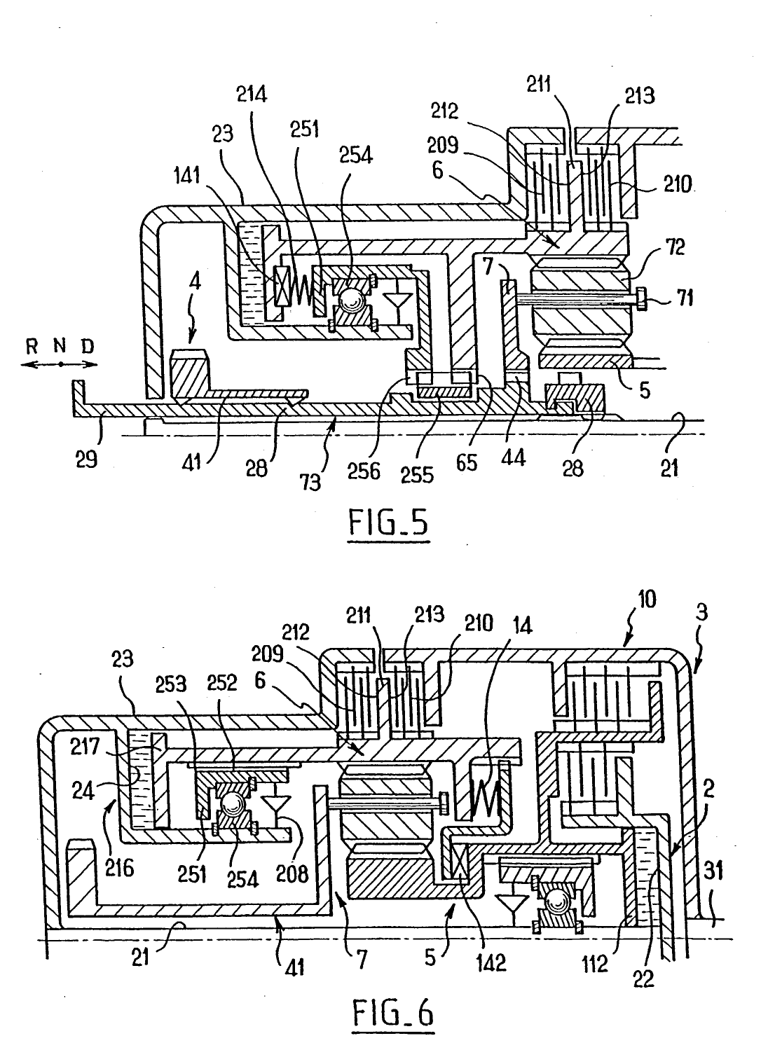

FIG. 5 is a view similar to FIG. 2, but being partial and showing a modified embodiment;

FIG. 6 is a view similar to FIG. 2 but showing a modified embodiment;

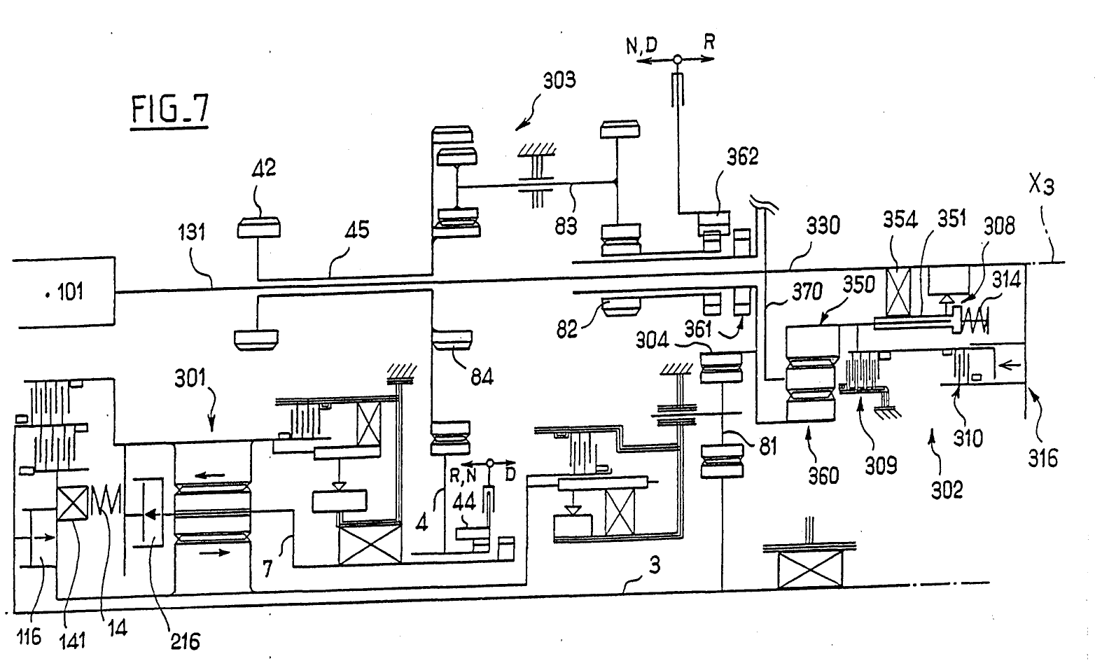

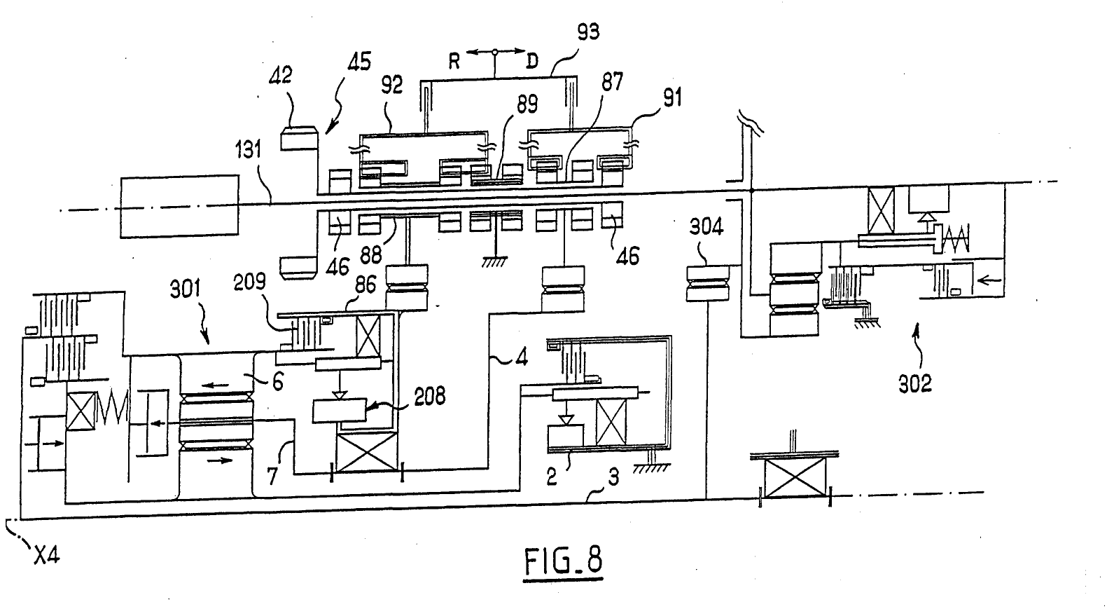

FIGS. 7 and 8 are diagrammatic views of two further embodiments of the invention;

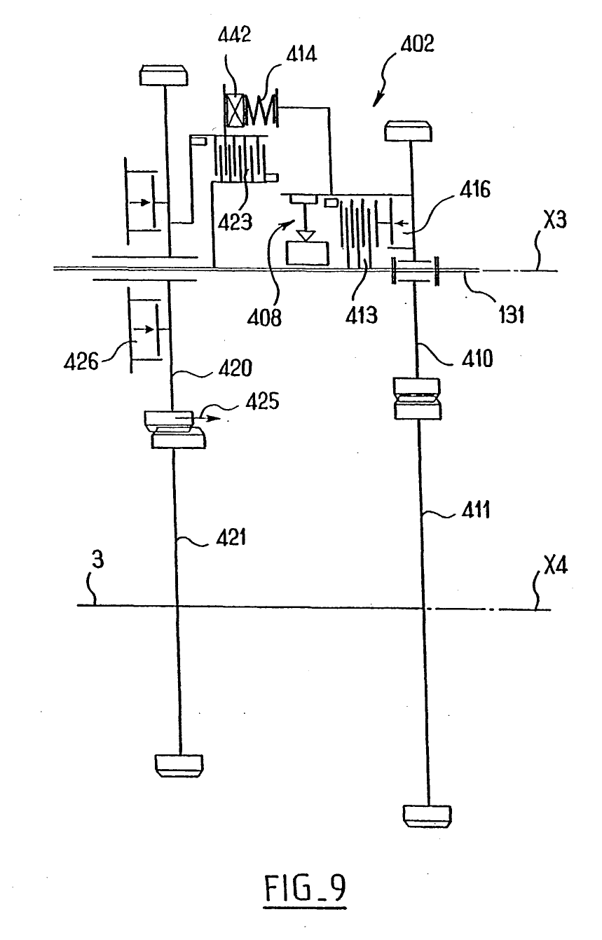

FIG. 9 is a modified embodiment of the right part of FIG. 8, corresponding to the two-ratios mechanism;

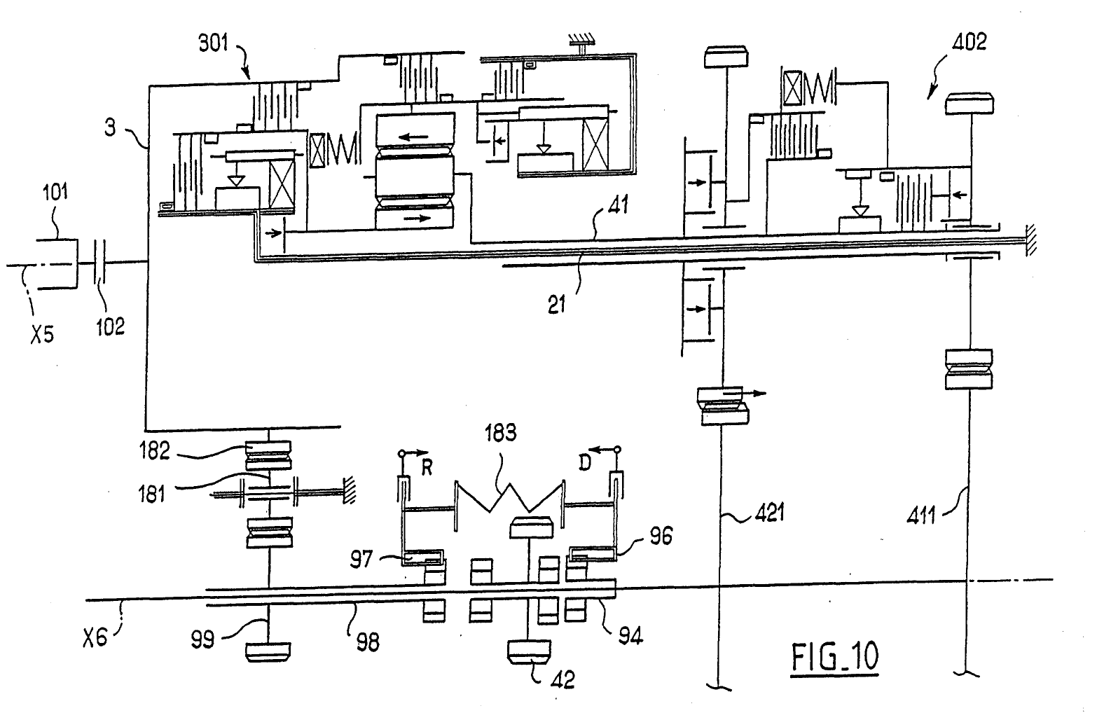

FIG. 10 is a diagrammatic view of another embodiment of the invention;

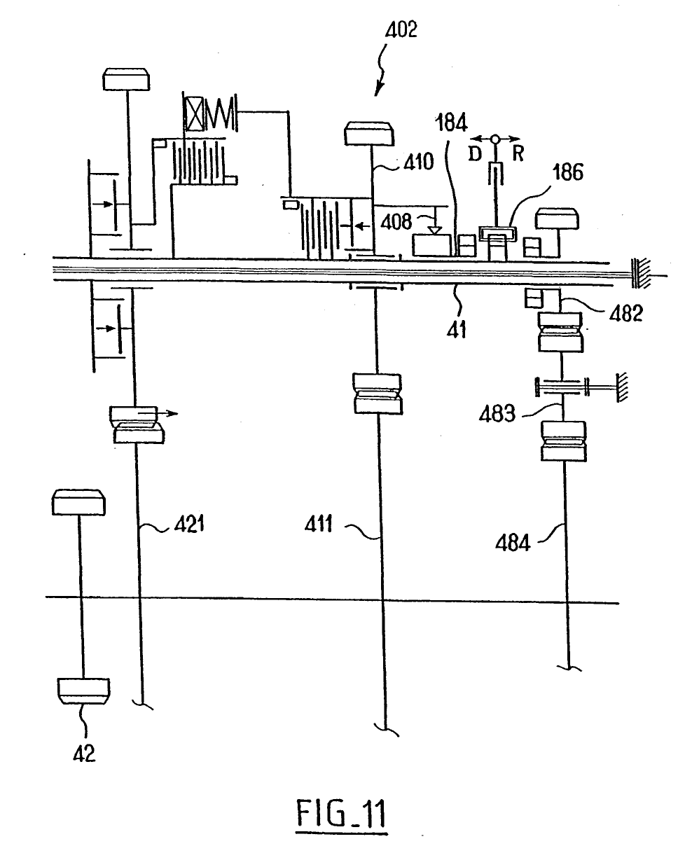

FIG. 11 is a diagrammatic view of a modified embodiment of the right part of the embodiment of FIG. 10; and

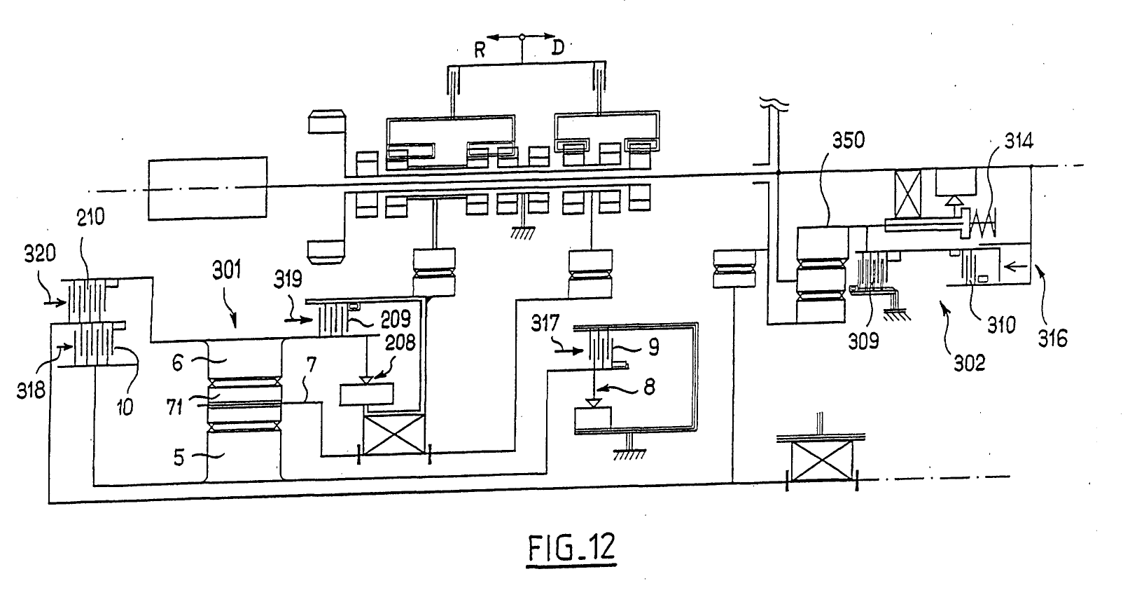

FIG. 12 is a diagrammatic view of a still further embodiment of the transmission device according to the invention.

In the example shown in FIG. 1, the transmission device is essentially comprised of a differential mechanism 1 comprising

a casing element 2, which is only partly represented and comprises i.a. a stator shaft 21, which is made stationary against translation and rotation, and extends along a main axis X of the mechanism;

an input rotary connection element 3, which is prevented from translation with respect to the casing element 2 and comprises an input shaft 31 extending along the main axis X beyond an end of the stator shaft 21, the input shaft 31 being intended to be directly or indirectly connected to a drive engine shaft of vehicle;

an output rotary connection element 4 intended to be connected, at least indirectly, to the vehicle wheels, and comprising a tubular shaft 31 arranged along axis X with a possibility of relative rotation around the stator shaft 21;

a sun wheel rotary element 5 arranged along axis X around the stator shaft 21 and capable of rotation with respect to the latter about axis X;

a rotary crown element 6 which is rotatably mounted about the axis X and arranged about the sun wheel element 5 and the stator shaft 21, the input connection element 3 having a bell-shaped element 32 by which the crown-wheel 6 is made fast with the input shaft 31;

a planet-carrier rotary element 7 which is integral with the output shaft 41 and carries spindles 71 which are regularly distributed about axis X and eccentrated with respect to the main axis X and on which planets 72, which are freely rotatable thereon, mesh simultaneously with the sun-wheel element 5 and the crown wheel element 6, thereby to form with them an epicyclic train;

a one-way clutch 8 which is merely symbolically represented and which prevents the sun-wheel element 5 from rotating with respect to the casing element 2 in a direction which would be contrary to that of the input shaft 31.

Would the transmission device be limited to what has just been described, it would operate only as a speed-reducing gear and only if the torque applied onto the input shaft 31 is a motive torque. In such a case, the load undergone by the planet carrier 7 from the output shaft 41 tends to stop the spindles 71 so that the motive torque applied onto the crown-wheel 6 tends to cause reverse rotation of the sun-wheel element 5. But this is prevented by the one-way clutch 8, so that the sun-wheel element 5 is stopped and the planet carrier 7 rotates at a speed which is intermediate between the zero speed of the sun-wheel element 5 and the speed of the crown-wheel 6 corresponding to that of the input shaft 31.

If the torque applied to the engine shaft 31 is negative, i.e. when the engine of the vehicle operates has a brake, the wheels of the vehicle tend, through the output shaft 4, to cause the planet carrier 7 to rotate faster than the crown-wheel 6 connected to the input shaft 31 and this tends to cause rotation of the sun-wheel 5 still faster than the planet carrier 7, an occurrence which is not prevented by the one-way clutch 8. This faulty operation must be avoided and would result in the engine coming back to idle without braking the vehicle. Therefore, there is provided between the sun-wheel element 5 and the casing element 2 a first friction coupling means—or brake 9—which is mechanically in parallel with the one-way clutch 8. When engaged, the brake 9 makes the sun-wheel 5 stationary with respect to the casing element 2 and thus allows the transmission device to operate as a speed-reducing gear when the torque applied to the input shaft 31 is negative, in the same manner as when the torque is positive. The brake 9 may be dimensioned in a manner which is just enough for the braking operation, which involves much weaker torques than the peak motive torque.

The transmission device furthermore allows to realize a direct drive ratio thanks to a second friction coupling means—or clutch—10 capable of selectively coupling for common rotation two of the three rotary elements 5, 6, 7 of the epicyclic train so that the whole epicyclic train rotates as a sole part about the axis X. This is automatically permitted by the free wheel 8 but needs to disengage the brake 9.

According to an important feature of this invention, the second friction coupling means 10 is associated to the same rotary element, i.e. in the represented example to the sun-wheel element 5, as the other already described coupling meams, i.e. the one-way clutch 8 and the first coupling means 9.

More particularly, in the represented example, the second friction coupling means is mounted operatively between the sun-wheel element 5 and the input connection means 3.

It has been explained hereinabove that engagement of the second friction coupling means 10 needs to disengage the first friction coupling means 9. Conversely, engagement of the brake 9 needs to disengage clutch 10. To this end, according to a further important feature of the invention, a single control member 111 operates as an inverter between two stable conditions in each of which a respective one of the friction coupling means 9, 10 is engaged and the other, respectively, is disengaged. In the illustrated examples, inverter control means 111 is an axially movable pressure member. When urged towards the right of FIG. 1, pressure member 111 engages brake 9 and disengages clutch 10. When urged towards the left of FIG. 1, pressure member 111 disengages brake 9 and engages clutch 10. Shifting from one to the other of these two stable conditions is performed by an axial translational movement.

Pressure member 111 is integral with the sun-wheel element 5 and therefore rotates at the same speed of rotation as the latter. Since both friction coupling means 9 and 10 both have the function of selectively connecting the sun-wheel element 5 with a respective other element of the mechanism 1, the integral connection of pressure member 111 with sun-wheel element 5 allows to realize pressure member 111 in the form of a common pressure member having two opposed pressing faces, i.e. a pressing face 112 for the stack of discs of brake 9 and a pressing face 113 for the stack of discs of clutch 10.

Generally speaking, the one-way clutches available in the commerce need to be mounted between two components which are axially stationary with respect to each other. Thus, taking into account the axial movability of sun-wheel element 5, the one-way clutch 8 cannot be directly mounted between the sunwheel element 5 and the casing element 2. For this reason, there is provided a support 51 having on its outer periphery axial splines 52 engaging corresponding axial splines 53 of the sun-wheel element 5, whereby sun-wheel element 5 is slidable with respect to the support 51 while being coupled for common rotation therewith. The support 51 is made axially stationary with respect to the casing element 2 by means of an axially unslidable bearing 54 mounted between the support 51 and the stator shaft 21. The one-way clutch 8 is also mounted between support 51 and stator shaft 21 in parallel with bearing 54.

For the inverting control of both friction coupling means 9 and 10, the inverter control means 111 is subjected to the coordinated action of three actuating means:

a first actuating means consists of the already described integral connection between the inverter control means 111 and the sun-wheel element 5. By virtue of this integral connection, the inverter control means 111 is subjected to the axial thrust occurring in the sun-wheel element 5 due to the helical shape of its teeth. This thrust is a measurement of the torque transmitted by the teeth;

a second actuating means comprises at least one spring 114, e.g. a stack of BELLEVILLE washers, interposed between support 51 which is axially stationary and the sun-wheel element 5;

the third actuating means is an hydraulic actuator 116 comprising an annular chamber 22 formed within the casing element 2, and a piston 117 which is integral with the inverter control member Ill and has an annular shape around axis X. Piston 117 is thus rotating about axis X within chamber 22 which is integral with the casing element 2.

FIG. 1 illustrates with arrows F1 and F2 the two possible directions for the tooth thrust experienced by the sun-wheel element 5. For a given direction of inclination of the teeth, the axial thrust appears in a corresponding given direction when the torque applied onto the input shaft 31 is motive, and in the contrary direction when the torque applied onto the input shaft 31 is negative (engine brake operation).

Assuming that the tooth thrust is oriented towards the right (arrow F1) when the torque is motive, the operation is as follows:

during starting, the springs 114 maintain brake 9 engaged and clutch 10 disengaged: the transmission device operates as a speed-reducing gear. During transmission of a motive torque, the teeth axial thrust F1 reinforces engagement of clutch 9 due to being added to the force of springs 114;

for shifting to the upper transmission ratio, an appropriate hydraulic pressure is applied to the actuator 116 for overcoming the force of springs 114 and the force F1 if any;

for causing the device to shift back from the direct drive ratio to the speed-reducing pressure, it is only necessary to release with a desired progressivity the pressure within chamber 22 of actuator 116.

During engine brake operation, the tooth thrust is reversed while taking a relatively low value which is not enough for overcoming the springs force 114. The device thus normally operates as a speed reducing gear except if an appropriate hydraulic pressure is applied within the chamber 22. During transition between both operating conditions, i.e. between both stable conditions of the control member 111, there is an intermediate condition where none of both friction coupling means is engaged. Assuming that the torque applied to the input shaft 31 is motive, the simultaneous disengagement of both coupling means 9 and 10 is not a problem since the sun-wheel element 5 remains stuck by the one-way clutch 8 so that the operation takes place in the speed-reducing mode. If by contrast the torque applied to the input shaft 31 is negative, there is a theoretical risk that the speed of rotation of the sun wheel element 5 increases, and that the speed of the input shaft 31 decreases while the output shaft 41 would accelerate. But practically this effect is small taking account of the inertia of the load applied to shaft 41 (the mass of the vehicle), of the low value of the negative torque applied to the shaft 31, and of the short duration of this situation.

It is also possible to chose the angle of helix of the teeth so that the tooth thrust occurs in the direction F2 when the torque applied to the input shaft 31 is motive. In such a case, the spring 114 have to be powerful enough for maintaining the device in the speed reducing operation in all the situations where this may be practically desirable against the tooth thrust F2. To this end, it is not necessary that the springs provide a great excess of force, it is enough that the clutch 10 be released even if brake 9 is only weakly engaged, since the one-way clutch 8 performs the function of maintaining sun-wheel element 5 stationary. During the engine brake operation, brake 9 is more tightly engaged since the tooth thrust is reversed and adopts direction F1.

For the direct drive operation, the chamber 22 is fed with a pressure which is high enough for engaging clutch 10 strongly enough.

As shown in phantom lines in FIG. 1, it is possible to replace springs 114 by springs 118 mounted between the support 51 and the inverter control member 111 so as to act no longer in a direction contrary to actuator 116 but in the same direction as the latter. In such a case, and if as shown no other actuating means is provided, it is necessary to chose that the tooth thrust be in the direction F1 when the torque applied to the input shaft 31 is motive. The operation occurs in the speed-reducing mode when the tooth thrust overcomes the contrary thrust of spring 118 and of the pressure prevailing in actuator 116, if any.

Shifting to the direct drive operation occurs when the tooth thrust F1 sufficiently decreases and/or when a pressure or a supplemental pressure sufficiently high is applied within the chamber of actuator 116. The engine brake operation necessarily occurs in direct drive because all the actuating forces are then directed towards the left of FIG. 1.

Still other combinations are possible, e.g. by causing the actuator to operate in a direction contrary to the springs 118. In such a case, the springs 118 tend to promote direct drive operation and the actuator may be energized for promoting engine brake operation. It is then advantageous to chose the direction F1 for the tooth thrust when the torque applied to the input shaft 31 is motive. For the engine brake operation, the tooth thrust is reversed and promote direct drive operation but this can be selectively counteracted by an appropriate hydraulic pressure.

The example of FIG. 2 will be described only as to its differences over FIG. 1.

FIG. 1 showed implementation of a so-called “grouped” control structure which strongly groups together all the control and coupling members practically on a single one of the rotary elements of the planetary train, i.e. the sun-wheel 5. This provides the possibility of performing other controls and other selective couplings on at least one other rotary element of the planetary train, for providing further transmission ratios. In the example of FIG. 2, a second actuating and control structure is grouped onto the crown-wheel 6 of the planetary train 5, 6, 7.

In this embodiment, in addition to the sun-wheel element 5 which may be selectively connected with the input connection element 3 or with the casing element 2, the crown-wheel 6 can be selectively connected with the input connection element 3 and with the casing element 2, another portion 23 of which is now illustrated. The grouped control and coupling structure for the crown-wheel 6 is very similar to that described for sun-wheel element 5. More specifically, an inverter control member 211 is integral with crown-wheel 6 and axially displaceable therewith. Member 211 comprises a pressing face 212 for selectively engaging brake 209 operatively mounted between the crown-wheel 6 and the portion 23 of the casing, and an opposed pressing face 213 for selectively engaging clutch 210 mounted operatively between the crown-wheel 6 and the input connection element 3. The portion 23 of the casing element 2 defines a chamber 24 of an hydraulic actuator 216, with a piston 217 being fast with the crown-wheel 6 and slidable within said chamber. A support 251 is coupled for common rotation with but axially slidable relatively to the crown-wheel 6 thanks to splines 252, 253. Between the support 251 and the casing element portion 23, there is provided an axially unslidable bearing 254 in parallel with a one-way clutch 208 forbidding rotation of the crown-wheel 6 with respect to the casing element 2 in a direction contrary to the normal direction of rotation of the input shaft 31. Springs 214 mounted axially between the support 251 and the piston 217 axially urge the crown wheel 6 in a direction contrary to that of the hydraulic pressure which may prevail in chamber 24.

The transmission device according to FIG. 2 is capable of four main operating conditions, corresponding to the four possible combinations of stable conditions of the inverter control members 111 and 211:

if member 111 is in its stable condition toward the right of FIG. 2 and member 211 is in its stable condition toward the left of FIG. 2, both clutches 10 and 210 are disengaged. The result is a neutral condition because the input connection member 3 is discoupled from all the rotary elements of the planetary train;

starting from this neutral situation, a first transmission ratio is provided by causing control member 111 to move to its other stable condition while the crown-wheel 6 is kept stationary by brake 209 and/or by free-wheel 208. A first reduction ratio, corresponding to a low speed of rotation of the output shaft 41 with respect to the input shaft 31, is realised;

a second transmission ratio is realised by simultaneously or almost simultaneously changing the stable conditions of both inverter control members 111, 211 thereby to engage brake 9 and clutch 210, while disengaging clutch 10 and brake 209. This creates again the speed reduction mode operation of FIG. 1, which corresponds to a speed of the output shaft 41 which remains lower than that of the input shaft 31, but with a milder reduction than in the situation of the first transmission ratio which has just been described in relation with FIG. 2;

the fourth condition is a direct drive condition obtained by maintaining control member 211 of crown-wheel 6 in the condition causing engagement of clutch 210 and by causing control member 111 to move into its condition causing engagement of clutch 10. The input connection member 3 is thus simultaneously fast with the sun-wheel element 5 and with the crown-wheel 6, this realising the direct drive in the transmission device.

The sun-wheel element 5 having helical teeth, the crown-wheel 6 also has helical teeth and consequently, the grouped control and coupling structure associated with the crown-wheel 6 is also subjected to the coordinated action of three forces comprising a tooth thrust, a resilient force and a force which is selectively applied by hydraulic means.

Again, different combinations of directions of these three forces are possible as explained with reference to FIG. 1. In the example illustrated in FIG. 2, the grouped control and actuating structure associated with crown-wheel 6 has been reversed with respect to that associated with sun-wheel element 5 because in operation the tooth thrust in the crown-wheel 6 and in the sun-wheel element 5 are always equal and opposite. Consequently, in this non-limiting example, the combination of directions of the various actuating forces is the same for both grouped structures.

It is noticeable that despite provision of four operating conditions in a single simple epicyclic train, no control and no coupling concerns e.g. the planet carrier 7 and the output shaft 41, and no thrust bearing is necessary for transmitting thrust between rotary members having different speed.

As in the example of FIG. 1, the hydraulic pistons are positioned at relatively great distance from the associated rotary elements with which they are integral and simultaneously serve to axially guide the associated rotary elements of the planetary train. Thus, the splines 52, 53 and 252, 253 have no guiding function and therefore do not introduce noticeable friction which would tend to alter the torque signal produced by the tooth thrust.

An appropriate choice for the direction of the actuating forces, more specifically among the four possible combinations described as to the example of the grouped structure of FIG. 1, allows to minimise the energy which is needed for the hydraulic actuation and consequently the power consumption which is intrinsically necessary for operation of the transmission device.

During transition between the first and the second reduction ratio of FIG. 2, there is a risk that a transient situation appears, which would correspond to neutral or else to a direct drive. This can be avoided by appropriately synchronising the motions of both control members 111 and 211 by way of an appropriate control of the hydraulic pressure within each of chambers 22 and 24. For example, for the shift from the first to the second ratio, it is possible to start with engaging clutch 210 for progressively causing rotation of crown-wheel 6 until the speed ratio between the output shaft 41 and the input shaft 31 corresponds to the second reduction ratio and only at this stage beginning to release clutch 10 while going on increasing tightening of clutch 210 so that due to a mutual compensation of both processes, the transmission ratio remains then substantially constant, equal to the second reduction ratio, until achievement of the ratio-change process. It therefore appears that the invention allows, in a relatively simple manner, to synchronise substantially simultaneous changes of conditions of four friction coupling means.

In the neutral condition, springs 114 and 214 maintain brakes 9 and 209 in the engaged condition so that the whole epicyclic train and therewith the output shaft 41 are immobilised against rotation, whereby a parking brake is obtained. In this situation, it is possible to cause movement of the input shaft 31, for example by starting the vehicle engine, and then to progressively start the vehicle by progressively applying an hydraulic pressure within chamber 22 for progressively engaging clutch 10 and introducing a progressive start of the vehicle. Consequently, the transmission device of FIG. 2 allows to dispense with the clutch or torque converter which is conventionally inserted between the engine and the gearbox of a vehicle.

The transmission device of FIG. 3 will be described only as to its differences over that of FIG. 2.

In the example of FIG. 3, the transmission device comprises two differential mechanisms mounted in series, namely, in the following order from the input connection element 3 to the output connection element 4, a first mechanism 301 which is essentially similar to that of FIG. 2 and a second differential mechanism 302 which will be described in detail hereinbelow.

Mechanism 301 distinguishes over that of FIG. 2 in that the stator shaft 21 is tubular and surrounds the input shaft 31, the vehicle engine being assumed to be of the left of FIG. 3 and no longer on the right of the figure (case of FIG. 2).

The various components of the mechanism 301 may be recognised from their references which are identical to those of FIG. 2. However, piston 217 integral with the crown-wheel 6 is replaced by a piston 27 integral with the casing element 2 and it is the element 6 forming the crown-wheel which defines the corresponding hydraulic chamber designated by reference numeral 64. The springs 214 no longer bear onto the piston but are mounted about guiding rods 61 which are integral with the crown element 6, and slidably extend through the support 251 which is provided with appropriate bores. The springs 214 are mounted between a back face of the support and a flange 62 of the rods 61. For a better sliding guide function, the crown-element 6 is provided on an inner bore with a bushing 63 for sliding onto the outer peripheral face of the tubular shaft 41 which now represents not only the output shaft of the first mechanism 301 but also the input shaft of the second mechanism 302. Shaft 41 is thus attached to an input connection element of mechanism 302.

Mechanism 302 comprises a simple epicyclic train essentially comprised of a sun-wheel element 350, a crown element 360 and a planet-carrier 370. Crown 360 is integral with output element 4 and is made axially stationary by means of bearings 365 with respect to a sleeve 26 belonging to the casing element 2. The output element 4 comprises gear teeth 42 arranged coaxially with the main axis X. The gear teeth 42 are intended to mesh with a pinion, not shown, supported along an axis which is parallel to axis X. The planet-carrier element 370 carries eccentrated spindles 371 on which planets 372 are rotatably mounted, which mesh with the teeth of the sun-wheel element 350 and with the teeth of the crown-wheel element 360.

The sun-wheel element 350 is associated with a grouped coupling and control structure comprising brake 309 for selectively connecting the sun-wheel element 350 with the casing element 2, a clutch 310 for selectively connecting the sun-wheel element 350 with the input connection element 330, an inverter control member 311 comprised of a pressure member which is integral with the sun-wheel element 350 and comprises a pressing face 312 for engaging the brake 309 in one of its two stable conditions and an oppositely directed pressing face 313 for engaging clutch 310 in the other of its two stable conditions. The sun-wheel element 350 defines with the casing 2 a chamber 322 of an hydraulic actuator 316 disposed for urging sun-wheel element 350 towards the stable condition corresponding to engagement of clutch 310 and disengagement of brake 309 when fed.

According to a difference over the grouped structure associated with the sun-wheel element 5 of mechanism 301 the one-way clutch 308 is mounted in parallel with clutch 310 and no longer in parallel with brake 309. One-way clutch 308 prevents sun-wheel element 350 from rotating faster than the input connection element 330. However, the mounting fashion itself of the one-way clutch is similar to that already described: the one-way clutch 308 is mounted in parallel with an axially unslidable bearing 354 between the input connection element 330 and the support 351. The input connection element itself is axially immobilized with respect to the casing element 2 by a bearing diagrammatically illustrated as 333. The support 351 is coupled for common rotation with the sun wheel element 350 by means of splines 352, 353. Springs 314 are mounted between the support 351 and the sun wheel element 350 for urging the sun-wheel element 350 in a direction opposed to that defined by the pressure in the hydraulic chamber 322. The teeth of the epicyclic train are helical and consequently, as in all the grouped structures described hereinabove, sun-wheel element 350 is subjected to a combination of three forces comprising the tooth thrust, the resilient force of the springs 314 and the hydraulic pressing force in the chamber 322.

The mechanism 302 furthermore comprises a dog-clutch system 373 comprising a control member 374 carrying coupling teeth 376. The control member 374 is movable between the neutral position “N” which is illustrated, a forward drive position “D” in which the planet carrier 370 is coupled for common rotation with the input connection element 330 of the second mechanism 302, and a reverse drive position “R” in which the planet carrier 370 is discoupled from the input connection element 330 and coupled with the sleeve 26 integral with the casing element. The control member 374 is a tube which is movably inserted between the stator shaft 21 and the stator sleeve 26.

Operation of the second mechanism 302 will now be described when the dog clutch is in the “D” position allowing two different forward drive ratios.

When the clutch 310 is engaged, the input connection element 330 is connected for common rotation at the same time with the sun wheel element 350 by the clutch 310 and with the planet carrier 370 by the coupling teeth 376 of the dog clutch 373. The mechanism 302 thus operates in a direct drive mode.

When the clutch 310 is released, and the brake 309 engaged, the sun-wheel element 350 is blocked with the casing element 2 and the input connection element 330 solely drives the planet-carrier 370. Consequently, the planets 372 roll about the teeth of the sun-wheel 350 and cause the crown-wheel 360 to rotate faster than the planet-carrier 370. The mechanism 302 then operates in an overdrive mode.

During transition between these two stable conditions, the crown 360 tends to be retarded by the load applied to the output element 4 and consequently the sun-wheel element 350 tends to rotate faster than the assembly comprised of the planet carrier 370 and the input connection element 330. But this is prevented by the one-way clutch 308.

When the dog clutch device 373 is in the “R” position, the planet carrier 370 is prevented from rotation and consequently the planets 372 operate as movement reversal means between the sun-wheel 350 and the crown wheel 360. In this case, clutch 310 must be engaged by an appropriate hydraulic pressure within chamber 322 against the springs 314 so that the motion introduced by input connection element 330 be transmitted by the sun-wheel element 350. The movement reversal occurs with a speed reduction since the diameter of the crown 360 is greater than that of the teeth of the sun-wheel element 350.

By an appropriate choice of the ratios between the different diameters of the toothed elements, a choice of which FIG. 3 gives an approximate idea, the transmission device of FIG. 3 provides six forward drive ratios which are appropriately distributed when the dog-clutch device 373 is in the “D” position.

These six ratios are the following:

for the first overall ratio, the mechanism 301 operates with its first speed reduction ratio (the most speed-reducing one) and the second mechanism 302 operates in its lower (direct drive) mode;

for the second overall ratio, the mechanism 302 shifts into the overdrive condition while the mechanism 301 remains in the strongly speed-reducing operation;

for the third overall ratio, the mechanism 301 operates with its second ratio (moderate speed-reduction) and the mechanism 302 operates in its direct drive mode;

the fourth ratio is a direct drive throughout the whole transmission;

the fifth ratio is obtained when the mechanism 301 operates with its second ratio (moderate speed-reduction) and mechanism 302 in the overdrive mode, and

in the sixth ratio, the mechanism 301 operates in direct drive mode and the mechanism 302 in over-drive mode;

for the reverse drive, with the dog clutch 373 in the “R” position, a convenient ratio is obtained when the mechanism 301 is in its second ratio operation (moderate speed reduction).

Position, “N” of the dog clutch 373 results in releasing the output element 4, a condition which may be useful, e.g. for pushing the vehicle by hand or towing it despite the fact that in the absence of energisation of the mechanism 301, a parking brake condition is realised in mechanism 301. This possibility of neutralizing the parking brake function results from mechanism 301 being located upstream of the dog-clutch system with respect to the power flow path between the engine and the wheels of the vehicle.

The transmission device of FIG. 3 is remarkable in that it provides six ratios and a reverse with only two simple epicyclic trains, only three hydraulic pistons and six friction coupling means. Furthermore, the hydraulic actuators only supply a complementary force and their energy consumption is consequently reduced. Among the six friction couplings, there are always three of them in the engaged condition, which consequently do not generate any residual friction in the transmission.

The way in which the three ratios of the first mechanism 301 are obtained in a basic epicyclic train, generates a much greater ratio-gap between the first and the second ratio than between the second and the direct drive ratio. More specifically, the first ratio-gap is substantially equal to ore than the square of the second gap, and still more typically about a cubic of the second ratio gap. For example, the ratios are 1:4.2, 1:1.4 and 1:1, giving a first ratio gap of 4.2/1.4=3.00 between the first and the second ratio, and a second ratio gap of 1.4/1=1.4 between the second and the direct drive ratio. The overdrive ratio in the second mechanism is selected so as to be intermediate between the first and of the second ratio gaps in the first mechanism, i.e. about 1.8, thus with the overdrive ratio being about 1:1.8.

The example of FIG. 4 will be described only as to its differences over that of FIG. 3. In the example of FIG. 4, the mechanisms 301 and 302 are essentially identical to those of FIG. 3 but are arranged along axes X1 and X2 which are parallel and spaced apart from each other. The output element 41 of the mechanism 301 carries an output gear 43 which meshes with an input gear 334 of mechanism 302, this input gear 334 being integral with the input connection element 330- In the mechanism 302, there is no longer the input shaft 31, nor the stator shaft 31, and consequently the input connection element 330 occupies the central place with a shaft 336 carrying a gear 334 and surrounded by the sleeve-shaped control member 374 of the dog clutch.

The bi-axial arrangement of FIG. 4 is simple to realise due to the fact that both mechanisms 301, 302 are merely connected to each other by a single rotating connection (of the output shaft 41 of the first mechanism with the input connection element 330 of the second mechanism) and allows a particularly short design. It is therefore possible to contemplate, for example, a straight-six cylinder engine transversely mounted in the vehicle and associated with a six-speed automatic transmission. The low axial space-requirement is furthermore enhanced by the possibility of dispensing with a clutch or torque converter between the engine and the transmission device proper.

The example of FIG. 5 will be described only for its differences over that of FIG. 2.

The planet carrier 7 is no longer rigidly connected to the output shaft 41. There is introduced in the mechanism a dog-clutch device 73 comprising:

a dog clutch 44, which is provided with an actuation member 29 and connected for common rotation with the output shaft 41, and axially movable between a “N” (neutral) position, a “D” (forward drive) position which is illustrated, performing a coupling for common rotation between the planet carrier 7 and the output shaft 41, and a “R” (reverse) position performing a coupling between the crown-wheel 6 and the output shaft 41. For this purpose, the crown wheel 6 is provided with dog clutch teeth 65;

a dog clutch 28 is mounted for being immobilized against rotation onto the stator shaft 21 and translatable together with the dog clutch 44. When the dog clutch 44 is in the R position, the dog clutch 28 couples the planet carrier 7 with the stator shaft 21, and consequently with the casing 2;

a dog clutch 255 is freely rotatable onto the dog clutch 44 and connected for common translation therewith. The dog clutch 255 permanently meshes with dog clutch teeth 256 provided on the support 251 which is no longer connected with the crown-wheel 6 except in the D position through the dog clutch 255 which, in this position, also meshes with the dog clutch teeth 65.

In forward drive, the operation is the same as in FIG. 2. In reverse drive, brake 209 and clutch 10 (FIG. 2) being engaged, the spindles 71 are blocked by dog clutch 28 and the planets 72 operate as movement reversal means between the sun-wheel element 5 connected to the input and the crown 6 which is connected to the output and allowed to rotate in reverse thanks to disconnection from the one-way clutch support 251. The speed-reduction is desirably high between the sun wheel 5 and the crown wheel 6.

There is thus realised with a single simple epicyclic train the entirety of an automatic transmission for a vehicle with three forward drive ratios, a reverse drive, a neutral, and a progressive starting device. For shifting from forward drive to reverse drive a dog-clutch system is normally satisfactory since such a shift normally takes place when the vehicle is stopped, a situation in which all the parts involved in the dog-clutch shift are stationary even if the engine rotates the input shaft 31.

In the reverse drive mode, the crown wheel 6 is rotating while the support 251 is stationary. Therefore, an axial thrust bearing 141 has been inserted between the spring 214 and the crown wheel element 6.

The embodiment of FIG. 6 will be described only as to its differences over that of FIG. 2.

The springs 114 and 214 have been suppressed and replaced by a single spring means 14 inserted between the sun wheel 5 and the crown wheel 6 for urging them in mutually contrary directions which are, for each of them, the same as those promoted by springs 114 and 214 in FIG. 2, i.e. to counteract the respective hydraulic actuators. Since the rotating speeds of the sun-wheel 5 and the crown-wheel 6 are, except in direct drive mode, different, a thrust bearing 142 has been inserted between the spring means 14 and one of the sun wheel 5 and crown wheel 6 elements, e.g., in the illustrated example, the sun wheel 5.

In each of the first and second ratios of the embodiment of FIG. 6, one of the hydraulic actuators is energized and pushes back the piston of the other actuator through the spring means 14 and the thrust bearing 142.

In direct drive operation, both hydraulic actuators are energized to compress the spring means 14 to a maximum while engaging, as in the embodiment of FIG. 2, the clutches 10 and 210.

In a modified embodiment, not shown, the spring 14 and thrust bearing 142 assembly may be replaced by a supplemental hydraulic actuator which is de-energized for the direct drive operation.

The embodiment of FIG. 7 will be described as to its differences over that of FIG. 4. Reference numerals used in FIG. 7 which were already used in foregoing drawing figures correspond to same or very similar components.

The embodiment of FIG. 7 comprises a second mechanism 302 which is generally similar to that of FIG. 4 with the following main exceptions:

the input connection element 330 of the mechanism 302 is integral with the planet carrier 370 and with the input shaft 131 of the transmission device;

the reverse drive means are no longer included in the second mechanism 302 and form a separate unit 303, which will be described later, within the transmission device;

the second mechanism 302 is mounted upstream of the first mechanism 301 along the power flow path between the input shaft 131 and the output teeth 42 of the transmission device; and

the crown wheel element 360 of the second differential mechanism 302 is integral with an output connection element 304 which consists of gear teeth driving, through an intermediate pinion 81, the toothed input rotary connection element 3 of the first transmission mechanism 301.

The first mechanism 301 is generally similar to that of FIG. 6 with the exception that its output rotary connection element 4 is connected to the planet carrier 7 through a dog clutch system having a dog clutch 44 which is movable between a “D” position connecting the planet carrier 7 with the output connection element 4 for common rotation therewith, and a “R,N” position in which the planet carrier 7 and the output connection element 4 are disconnected from each other, as shown.

The output connection element 4 of the first mechanism 301 is provided with gear teeth meshing with gear teeth of an intermediate output element 45 on which the output teeth 42 are integrally formed and which is rotatably mounted onto the input shaft 131 of the transmission device. Thus, the input (shaft 131) and the output (teeth 42) of the whole transmission device are coaxial. This is of advantage because it allows to freely orient the transmission device about the common axis X3 of the input and the output in the motor compartment of a vehicle, depending on the available space.

The reverse drive mechanism 303 is mounted about geometrical axis X3 so as to selectively by-pass the first mechanism 301. The reverse drive mechanism 303 comprises a dog clutch system 361 which selectively connects for common rotation the crown-wheel 360 of the second mechanism and its integral output connection element 304 with a pinion 82 which is freely rotatable about input shaft 131. Pinion 82 meshes with an intermediate eccentrated stepped pinion 83 which in turn meshes with a third tooth set 84 of the intermediate output member 45.

The arrangement is such that in direct drive, the direction of movement of the output teeth 42 is contrary to that of input shaft 131 by virtue of intermediate pinion 81 between the output connection element 304 of the second mechanism 302 and the input connection element 3 of first mechanism 301, whereas the output teeth 42 and the input shaft 131 have the same direction of rotation in the reverse drive mode. The dog clutch 362 of the dog clutch system 361 is movable between a “N,D” position, shown in FIG. 7, in which the output element 304 of the second mechanism 302 is disconnected from pinion 82 and a “R” position in which they are connected together. The dog clutches 44 and 362 are jointly actuated so that the reverse drive condition is realized when dog clutch 44 is in the “RN” position while dog clutch 362 is in the “R” position, the forward drive is realized when dog clutch 44 is in the “D” position while the dog clutch 362 is in the “N, D” position, and a neutral condition is realised when dog clutch 44 is in the “R, N” position and dog clutch 362 in the “N, D” position. In the forward drive position, a parking brake function is performed by the first mechanism 301 when the actuators 116 and 216 are de-energized, whereas the output teeth 42 are freely movable when the neutral condition is realised. Therefore, the input shaft 131 of the transmission device may be integrally connected with an engine shaft of an engine 101, without interposition of any input clutch or torque converter.

The embodiment of FIG. 8 will be described only as to its differences over that of FIG. 7.

The second mechanism 302 is similar to that of FIG. 7 except that its output connection element 304 is no longer connectable to a reverse drive mechanism, and directly meshes with gear teeth of the input connection element 3 of the first mechanism 301, instead of through the intermediate pinion 81 of FIG. 7.

The first mechanism 301 is identical to that of FIG. 7 except that the planet carrier 7 is permanently connected to the output element 4 of the first mechanism 301.

Furthermore, instead of selectively connecting the crown wheel 6 with the casing element 2, the clutch 209 and one-way clutch 208 assembly connects the crown-wheel 6 with a cage 86 which is rotatable about the axis X4 of the first transmission mechanism 301.

The output element 4 and the cage 86 are provided with respective gear teeth which mesh with corresponding teeth which are integral with respective rings 87, 88, which are rotatable about input shaft 131 and coaxially therewith. A stationary ring 89 is integral with casing element 2 and is axially aligned with rings 87 and 88 and mounted between them. The three rings 87, 88 and 89 are rotatable about a tubular shaft of intermediate connection element 45 and between two toothed flanges 46 of this tubular shaft. A first dog-clutch 91 selectively couples for common rotation ring 87 with the output teeth 42 of the transmission device for direct drive, or with the stationary ring 89 so as to immobilize the planet carrier 7 for reverse drive. A second dog-clutch 92 selectively connects for common rotation the second ring 88 with the output teeth 42 or with the stationary ring 89 so as to either connect the cage 86 with the output teeth for the reverse drive or to the casing 2 for the direct drive. Both dog clutches 91, 92 are synchronized by a coupling member 93.

The embodiment of FIG. 9 will be described only as to its differences over that of FIG. 8.

The second differential mechanism 302 is replaced with a two-speed layshaft mechanism 402 which simultaneously performs transfer of the power from axis X3 along which input shaft 131 extends, onto parallel axis X4 of the first differential mechanism 301, not shown, and more particularly from input shaft 131 of the transmission device to input connection member 3 of the first differential mechanism 301.

Mechanism 402 comprises two impeller pinions 410, 420, of different diameters, which are rotatably mounted onto input shaft 131, and mesh with respective receiver pinions 411, 421 which are integral with input connection element 3. The smaller one of the impeller pinions 410 is selectively coupled to input shaft 131 by a one-way clutch 408 mounted in parallel with a clutch 413 which is engaged when an actuator 416 is energized.

Impeller pinion 420 having the larger diameter is slidably mounted onto input shaft 131 and is selectively coupled for common rotation therewith when a friction clutch 423 is engaged. Engagement of clutch 423 is initiated by an hydraulic actuator 426 axially pushing impeller pinion 420 in the direction corresponding to the tooth thrust 425 experienced by impeller pinion 420 when transmitting a motive torque from input shaft 131 to input connection member 3. There is provided between impeller pinion 410 and 420 a spring means 414 in series with a thrust bearing 442.

The operation of the embodiment of FIG. 9 is as follows:

When none of the actuators 416 and 426 are energized and a motive torque is applied to input shaft 131, one-way clutch 408 drives impeller pinion 410, which in turn drives input connection element 3 with the lower of the two transmission ratios. The actuator 416 may be energized for maintaining the same transmission ratio in case the torque applied on input shaft 131 would become negative (engine-brake operation).

The mechanism 402 is shifted into its higher transmission ratio when actuator 416 is deenergized and actuator 426 is energized for engaging clutch 423. This results in a slower rotating speed of input shaft 131 while the rotating speed of impeller pinion 410, which is determined by the rotating speed of input connection element 3, remains unchanged, as allowed by one-way clutch—or free-wheel—408.

The embodiment of FIG. 10 will be described as to its differences over the previous embodiments.

The first mechanism 301 and the second mechanism 402 are mounted in series along a same geometrical axis X5. The vehicle engine 101 is connected to the input connection element 3 of the first mechanism 301 through an input clutch 102. The first mechanism 301 is essentially similar to that of FIG. 6 except that the output element is a tubular shaft 41 also forming the input connection element of the second mechanism 402. The second mechanism 402 is identical to that of FIG. 9 except that its input connection element is, as already mentioned, a tubular shaft through which the stator shaft 21 of the first mechanism 301 extends.

Instead of being rigidly connected to the input connection element 3, both receiver pinions 411 and 421 of the second mechanism 402 are rigidly connected to a ring 94 which is selectively connected to the output teeth 42 by a dog-clutch 96. Another dog-clutch 97 selectively connects the output teeth 42 with an intermediate reverse drive member 98 which integrally includes a pinion 99. An intermediate pinion 181 meshes with pinion 99 and with gear teeth 182 provided on the input connection member 3 of the first mechanism 301.

The intermediate output member 98, the output teeth 42 and the ring 94 as well as the receiver pinions 411 and 421 extend along a common axis X6 which is parallel to axis X5 of the first and second mechanism 301, 402.

Dog-clutches 96 and 97 are urged apart from each other by a spring 183 whereby, in the rest position of both dog-clutches, the output teeth 42 are disconnected both from the forward drive motion arriving through either one of receiver pinions 411 or 421, and from the reverse drive motion arriving through the intermediate reverse drive connection member 98. Starting from this situation, the forward drive mode is established by pushing dog clutch 96 toward dog clutch 97 being maintained at rest, and conversely the reverse drive mode is established by pushing dog clutch 97 towards dog clutch 96 being maintained at rest.

In the reverse drive mode, both the first mechanism 301 and the second mechanism 302 are by-passed.

The input clutch 102 is therefore necessary for allowing progressive start of the vehicle in reverse drive.

The example of FIG. 11 will be described as to its differences over that of FIG. 10.

The reverse drive connection 182, 181, 99, 98, 97 between the input of the first mechanism and the output teeth 42 is completely suppressed and the output teeth 42 are rigidly connected to the receiver pinions 411 and 421 as well as to a reverse receiver pinion 484. An intermediate pinion 483 meshes with the reverse receiver pinion 484 and with a reverse impeller pinion 482 mounted for free rotation about the tubular shaft 41 in the second mechanism 402.

Instead of being mounted between the impeller pinion 410 and the input connection element of the second mechanism, the one-way clutch 408 is now mounted between the impeller pinion 410 and a ring 184. A dog-clutch 186 selectively connects the tubular shaft 41 with the ring 184 for direct drive, or with the reverse impeller pinion 482 for reverse drive. Since power flows through the first mechanism 301 both for forward drive and reverse drive, this embodiment does not need any input clutch 102 (FIG. 10) between the engine 101 and the input connection member 3 of the first mechanism 301.

The embodiment of FIG. 12 will be described only as to its differences over FIG. 8.

The first mechanism 301 has been modified so that each friction coupling device 9, 10, 209, 210 is controlled by a specific actuator 317, 318, 319, 320, which are illustrated by mere arrows. The sun-wheel element 5 and the crown wheel element 6 are stationary in the axial direction. For this reason, it is no longer necessary to provide bearings in parallel with the one-way clutches 8, 208.

The spring means are eliminated.

In this embodiment, the available gear ratios are the same as in FIG. 8. However, the clutch engagements needed for realising each gear ratio, respectively, are determined by energising the corresponding ones of the hydraulic actuators.

The second mechanism 302 has not been modified over that of FIG. 8 but could have been modified in the same spirit as the first mechanism 301 by making sun-wheel element 350 axially unslidable, cancelling spring 314, and providing a specific actuator for each one of the friction coupling means 309 and 310 instead of the common one 316.

Of course the invention is not limited to the shown and described embodiments.

Other actuating forces than those represented may be involved, e.g. forces produced by centrifugal flyweights promoting operation with a higher transmission ratio when the rotating speed increases, or else a second hydraulic force in a direction contrary to the first one for being able to influence positively in one or the other direction the operating condition of a grouped actuation and control structure.

It has been seen in the embodiment of FIG. 2 and of those deriving therefrom, that even with two grouped control and coupling structures on a single simple train, one of the rotary elements of the differential mechanism (in the example the planet carrier) remains totally free of such structure. It could then be contemplated to provide a third grouped structure associated with the planet carrier.

This invention is compatible with complex differential mechanisms, having at least four rotary elements. It is then possible to increase the number of grouped coupling and control structures.

1- A transmission device wherein a differential mechanism (1, 301, 302) comprises:
a casing element (2);
an input rotary connection element (3, 303) and an output rotary connection element (4);
three rotary elements (5, 6, 7; 350, 360, 370) which are rotatable with respect to the casing element (2) and mutually intermeshed;
two friction coupling means (9, 10; 209, 210; 309, 310) between said elements;
a one-way clutch (8; 208; 308) forbidding one direction of relative rotation of a first one (5, 350) of the rotary elements with respect to a second one (2, 330) of said elements;
actuating means (114, 116; 214, 216; 314, 316) for said coupling means;
characterized in that
a first one (9; 209; 310) of said selective coupling means is mechanically in parallel with the one-way clutch (8; 208; 308);
a second one (10; 210; 309) of said selective coupling means is operatively mounted between said first element (5; 350) and a third one of said element (3; 2);
said two friction coupling means are coordinated by an inverter control means (11; 211; 311) between two stable states in each which one of the coupling means is engaged and the other is released, respectively:

2- A device according to claim 1, characterized in that the inverter control means is a common pressure member (11; 211; 311) which is movable between two end positions, each of which corresponds to one of the stable states, and which is acted upon by the actuating means.

3- A device according to claim 1 or 2, characterized in that the inverter control means is integral with the first element (5; 6; 350).

4- A device according to one of claims 1-3, characterized by comprising, mechanically in series with the one-way clutch (8; 208; 308) between the first rotary element (5; 350) and the second element (2; 330), a means for common rotation with axial displaceability (52, 53; 252, 253; 352, 353).

5- A device according to claim 4, characterized in that the first rotary element (5, 350) is guided for axial sliding independently of the means for common rotation (52, 53; 252, 253; 352, 353).

6- A device according to claim 4 or 5, characterized in that the means for common rotation (52, 53; 252, 253; 352, 353) is mounted operatively between one of the first and second elements and a one-way clutch support (51; 251; 351), and in that an axially unslidable bearing (54; 254; 354) is provided mechanically in parallel with the one-way clutch (8; 208; 308) and between the one-way clutch support and the other of said first and second elements.

7- A device according to one of claims 1-6, characterized in that the actuating means comprise an axial movability of the first element (5; 6; 350) under a tooth reaction thrust (F1, F2).

8- A device according to claim 7, characterized in that the actuating means comprise two antagonistic actuators (114, 116; 214, 216; 314, 316) one of which is capable of an action in the same direction as the tooth thrust.

9- A device according to claim 8, characterized in that one of the antagonistic actuators is at least one spring (114; 214; 314).

10- A device according to claim 9, characterized in that said at least one spring acts in a direction contrary to the tooth thrust.

11- A device according to one of claims 8-10, characterized in that the antagonistic actuator which is capable of an action in the same direction as the tooth thrust is a controllable actuator, preferably an hydraulic actuator (116; 216; 316).

12- A device according to one of claims 1-11, characterized in that the first element is a sun wheel (5; 350) of the differential mechanism (1; 302).

13- A device according to one of claims 1-12, characterized in that the second element is the casing element (2).

14- A device according to one of claims 1-13, characterized in that there is provided axially through the first element (5; 350) a stator shaft (21) belonging to the casing element (2), the latter forming the second element.

15- A device according to claim 14, characterized in that the stator shaft (21) is tubular and surrounds a shaft (31) which is fast with the third element (3).

16- A device according to claim 14 or 15, characterized in that the stator shaft (21) is surrounded by a tube (41) which is fast with the other connection element (4).

17- A device according to one of claims 1-15, characterized in that the third element is one of the connection elements (3; 330).

18- A device according to claim 17, characterized in that the device comprises a selective dog-clutch device for:
in a forward drive position, connecting a remaining one of the three intermeshed elements of the differential mechanism with the other connection element and the second element at least selectively with the casing element;
in a reverse drive position, connecting said remaining element of the differential mechanism with the casing element, and the second element with the other connection element.

19- A device according to claim 18, characterized in that the device comprises a third friction coupling means (210; 10) by which the third element (3) is selectively connected to a fourth one of the elements which is formed by one of the rotary elements (6; 5) other than the first element (5; 6).

20- A device according to claim 19, characterized in that the device comprises:
between the fourth element (6; 5) and another one (2) of the elements, a fourth friction coupling means (209; 9) in parallel with a second one-way clutch (208; 8); and
a second inverter control means (211; 11) which coordinates the third and the fourth coupling means between two stable conditions in each of which one of the third and fourth coupling means is engaged and the other one disengaged, respectively.

21- A device according to claim 20 in combination with claim 9 or 10, characterized in that the spring is mounted operatively between both inverter control means.

22- A device according to claim 20, characterized by said actuating means comprising a controllable actuator mounted operatively between said two inverter control means.

23- A device according to one of claims 20-22, characterized in that the second inverter control means (211; 11) is subjected to a tooth reaction thrust of said fourth element (6; 5), which is mounted for displacement under tooth thrust.

24- A device according to one of claims 19-23, characterized in that said other element to which said fourth element can be connected for rotation by the fourth coupling means is said second element (2).

25- A device according to one of claims 19-24, characterized in that one of the connection means (3) is adapted to be coupled with an engine shaft, without interposition of any starting clutch.

26- A device according to one of claims 1-25, characterized in that one of the connection means (41) is connected to a mechanism (302) providing at least two ratios.

27- A device according to claim 26, characterized in that the two-ratios mechanism transfers a motion from a differential mechanism axis to a second, parallel, axis.

28- A device according to claim 27, characterized in that the two ratio-mechanism comprises
two toothed wheels rotatively mounted onto a first connection shaft;
a second connection shaft having two pinions rigidly mounted thereon and having different diameters:
a clutch selectively coupling one of the toothed wheels with the first shaft;
a one-way clutch coupling the other toothed wheel with the first shaft when the clutch is deactivated;
an auxiliary clutch in parallel with the one-way clutch.

29- A device according to claim 28, characterized in that the toothed wheel associated with a clutch has a possibility of axial movement so that its tooth reaction participates to actuation of the clutch.

30- A device according to one of claims 27-29, characterized by comprising a reverse drive device which once activated by a dog-clutch, selectively by-passes the differential mechanism and the two ratio mechanism.

31- A device according to one of claims 27-29, characterized by comprising a reverse drive device which once activated by a dog-clutch, selectively by-passes the two-ratio mechanism between the axis of the differential mechanism and the second, parallel axis.

32- A device according to claim 26, characterized in that the mechanism having at least two ratios and the diffential mechanisms are arranged along two different parallel axes (X1, X2).

33- A device according to claim 32, characterized by comprising a supplemental connection member which is coaxial with the two-ratio mechanism and coupled with the connection element of the differential mechanism other than that which is coupled with the two-ratio mechanism, whereby input and output of the transmission device are co-axial.

34- A device according to claim 33, characterized by a reverse drive mechanism mounted between the two-ratio mechanism and the supplemental connection member, reverse control means being provided for selectively activating the reverse drive device and jointly desactivating the differential mechanism.

35- A device according to claim 33, characterized in that the differential mechanism and the supplemental connection member are connected by selective dog-clutch means causing the differential mechanism to operate either with several forward drive ratios, or with a reverse drive ratio.

36- A device according to claim 32, characterized in that the mechanism having at least two ratios (302) moreover provides a reverse drive ratio.

37- A device according to one of claims 26-36, characterized in that the two-ratio mechanism (302) is a second differential mechanism according to anyone of claims 1-9.

38- A device according to claim 37, characterized in that, in the second mechanism, the second element (330) is a connection element, and the third element is a casing element (2), the remaining one (360) of the three rotary elements of the second differential mechanism (302) being connected to the other connection element (4).

39- A device according to claim 38, characterized in that said second element of said second mechanism is the connection element with the first mechanism (301).

40- A device according to one of claims 38 or 39, characterized in that said other rotary element (370) of the second mechanism (302) is selectively connectable to the connection element (330) for providing a direct forward drive ratio and, selectively, a different forward drive ratio, or to the casing element (2) for providing a reverse drive ratio.

41- A device according to one of claims 38-40, characterized in that the two-ratio mechanism is placed upstream of the differential mechanism, with respect to the power flow direction through the transmission device.

42- A device according to one of claims 1-9, characterized in that the second element (330) is a connection element, and the third element is a casing element (2), the remaining one (360) of the three rotary elements being connected to the other connection element (4).

43- A device according to claim 42, characterized in that the second element is the input connection element (330).

44- A device according to one of claims 38-43, characterized in that the connection element (330) forming the second element is moreover selectively connectable to another one of the rotary elements (370).

45- A device according to one of claims 38-43, characterized in that the remaining one of the three rotary elements is selectively connected to a reverse drive device.

46- A device according to claim 42 or 43, characterized in that said other rotary element (370) is selectively connectable to the connection element (330) for providing a direct forward drive ratio and, selectively, a different forward drive ratio, or to the casing element (2) for providing a reverse drive ratio.

47- A device according to one of claims 38-46, characterized in that said different forward drive ratio is an overdrive ratio.

48- A transmission device wherein a transmission mechanism comprises:
an input rotary connection element (3) and an output rotary connection element (4);
at least two rotary elements which are rotatable with respect to the casing element and are, at least indirectly, mutually intermeshed;
at least one friction coupling means capable of providing a neutral condition in the transmission mechanism when disengaged, and a power transmission relationship between said two connection elements in the engaged condition;
actuating means for actuating the friction coupling means, said actuating means comprising:
c) two antagonistic actuating means, at least one of said two antagonistic actuating means being controlable;
d) an axial movability of at least one of said two intermeshed rotary elements, and transmission means for transmitting an axial tooth thrust of said intermeshed rotary element to a pressure member of the friction coupling means.

49- A device according to claim 48, characterized in that the thrust transmission means are an integral connection between one of the intermeshed rotary elements and the pressure member.

50- A device according to claim 48 or 49, characterized in that the controllable antagonistic means is mounted for counteracting the tooth thrust during transmission of a motive power.

51- A device according to one of claims 48-50, characterized in that the controllable antagonistic means is mounted for acting in the same direction as the tooth thrust during transmission of the motive power.

52- A device according to one of claims 48-51, wherein the actuating means comprise a spring counteracting the controllable antagonistic means.

53- A device according to one of claims 48-52, characterized in that the input connection element is permanently connected to a prime mover (101).

54- A device according to one of claims 48-53, characterized in that the pressure member (113) belongs to an inverter control member (111) integrally carrying another pressure member (112) for another friction coupling means (9), the inverter control member being movable between two end positions in each of which a respective one of the coupling means is in the engaged condition and the other in the disengaged condition.

55- A device according to claim 54, characterized in that one of the friction coupling means is an auxiliary coupling means mounted mechanically in parallel with a one-way clutch mounted operatively between two elements of the transmission mechanism.

56- A device according to one of claims 49-54, characterized in that said at least one friction coupling means comprises two such friction coupling means.

57- A device according to claim 56, characterized in that said two such friction coupling means are mounted operatively between one of said connection elements and a respective one of said intermeshed rotary elements, the neutral condition being created when said two such friction coupling means are both in the disengaged condition.

58- A transmission device wherein a transmission mechanism comprises:
an input rotary connection element (3) and an output rotary connection element (4);
at least two rotary elements which are rotatable with respect to the casing element and are, at least indirectly, mutually intermeshed;
at least two friction coupling means, each of which is capable of providing, when in an engaged condition, a respective power transmission relationship between said two connection elements, with a respective transmission ratio;
antagonistic actuating means for actuating the friction coupling means, said actuating means comprising at least one controllable antagonistic actuating means:
wherein a neutral condition is realised in the transmission mechanism when the two friction coupling means are both in a disengaged condition.

59- A device according to claim 57 or 58, wherein both friction coupling means are mounted between said respective one of the intermeshed rotary elements and a same one of said input and output connection elements.

60- A device according to claim 59, wherein said same one connection element is the input connection element.

61- A device according to one of claims 57-60, wherein a further transmission ratio is provided when both friction coupling means are in the engaged condition.

62- A device according to claim 61, wherein the further transmission ratio is a direct drive transmission ratio in which power is transmitted through the intermeshed rotary elements, whereby tooth thrust is maintained during direct drive.

63- A device according to claim 56 or 57, characterized in that the pressure member (113, 213) of each of said two friction coupling means belongs to a respective inverter control member (111, 211) integrally carrying another pressure member (112) for a respective other friction coupling means (9), each inverter control member being movable between two extreme positions in each of which a respective one of the coupling means is in the engaged condition and the other in a disengaged condition.

64- A device according to claim 58, characterized in that at least one of said other friction coupling means is an auxiliary coupling means mounted mechanically in parallel with a one-way clutch mounted operatively between two elements of the transmission mechanism.

65- A device according to claim 55 or 64, characterized by comprising, mechanically in series with the one-way clutch (8) a means for common rotation with axial slidability which is effective between the one-way clutch and one of the two elements between which the auxiliary coupling means is mounted.

66- A device according to claim 65, characterized in that the means for common rotation (52, 53; 252, 253; 352, 353) is mounted operatively between one of the two elements and a one-way clutch support (51; 251; 351), and in that there is provided, mechanically in parallel with the one-way clutch (8; 208; 308), an axially unslidable bearing (54; 254; 354), between the one-way clutch support and the other of said two elements.

67- A device according to claim 66, characterized in that one of the antagonistic means bears onto the support.

68- A device according to one of claims 48-67, characterized by comprising, in series with said transmission mechanism, a second mechanism providing at least two ratios.

69- A device according to claim 68, characterized in that the second mechanism comprises reverse drive means.

70- A device according to one of claims 48-68, further comprising in series with said transmission mechanism a reverse drive mechanism, having reverse drive means

71- A device according to claim 70 in combination with claim 68, characterized in that the reverse drive mechanism is operable for by-passing the second mechanism.

72- A device according to one of claims 47-71, in which:
the input connection means are permanently connected with the prime mover for simultaneous rotation;
the neutral condition is a parking brake condition;
the output rotary connection element is connected with a load to be driven through dog-clutch means.

73- A device according to claim 71, wherein the dog-clutch means is capable of three conditions:
a forward drive and parking condition;
a neutral condition allowing free rotation of the load;
a reverse drive condition.

74- A transmission device wherein a differential mechanism (1) comprises:
a casing element (2);
an input rotary connection element (3) and an output rotary connection element (4);
two coaxial toothed elements (5, 6) which are rotatable with respect to the casing element (2) and comprise:
a sun wheel (5); and
a crown-wheel (6); and
a planet-carrier element (7) supporting planets (72) meshing with the sun-wheel (5) and the crown-wheel (6);
connection means between the planet carrier (7) and the output rotary connection element;
selective coupling means between the coaxial toothed elements, the casing element and the input connection element;
characterized by said selective coupling means comprising:
a first grouped structure for selectively coupling the sun-wheel (5) with the input connection element and with the casing element (2);
a second grouped structure for selectively coupling the crown wheel (6) with the input connection element and with the casing element,
thereby to provide:
a low ratio when the sun-wheel is connected to the input connection element and the crown-wheel is connected to the casing element;
an intermediate ratio when the sun-wheel (5) is connected to the casing element (2) and the crown-wheel (6) is connected to the input connection element (3);
a direct drive ratio when the sun-wheel (5) and the crown-wheel (6) are both connected to the input connection element.

75- A device according to claim 74, characterized in that there is provided a neutral condition when the sun-wheel (5) and the crown-wheel are both connected to the casing element.

76- A device according to claim 74 or 75, characterized in that at least one of the grouped structure comprises
between the corresponding coaxial toothed element and the casing element, a first friction coupling means (9) mechanically in parallel with a one-way clutch (8);
a second friction coupling means (10) mounted operatively between the coaxial toothed element and the input connection element.

77- A device according to claim 76, characterized in that said first and second friction coupling means are coordinated by an inverter control means (11; 211; 311) between two stable states in each which one of the coupling means of the grouped structure is engaged and the other is disengaged, respectively.

78- A device according to claim 77, characterized in that the inverter control means is a common pressure member (11; 211; 311) which is movable between two end positions, each of which corresponds to one of the stable states, and which is acted upon by the actuating means.

79- A device according to claim 77 or 78, characterized in that the inverter control means is integral with the corresponding coaxial toothed element (5; 6; 350).

80- A device according to one of claims 74-79, characterized in that one of the connection elements (6) is connected to a two-ratios mechanism.

81- A device according to claim 80, characterized in that a lower one of the two ratios is a direct drive (74).

82- A device according to claim 80 or 81, characterized in that a higher one of the two ratios is an overdrive (75).

83- A device according to anyone of claims 80-82, characterized by providing six gears by the following combinations:
first gear:low ratio and lower ratio;
second gear:low ratio and higher ratio
third gear:intermediate ratio and lower ratio;
fourth gear:direct drive and lower ratio;
fifth gear:intermediate ratio and higher ratio;
sixth gear:direct drive and higher ratio.

84- A device according to one of claims 74-83, characterized in that connection means between planet carrier and the output connection element comprise a dog-clutch (44, 28; 91) by which the planet carrier can be discoupled from the output connection element (4; 42) and connected to the casing element (2), another dog-clutch (255; 92) allowing to release one of the coaxial toothed elements (6) from at least part of its corresponding grouped structure and to connect it to the output connection element (4; 42), for providing a reverse drive condition.

85- A transmission device comprising:
a three-speed mechanism providing a low ratio, an intermediate ratio and an upper ratio, with a first ratio-gap between the low ratio and the intermediate ratio being at least about the square of a second ratio-gap between the intermediate ratio and the upper ratio;
a two-speed mechanism mounted in series with the three-speed mechanism and providing a lower and a higher ratio, with a third ratio-gap therebetween which is intermediate between said first and said second ratio-gaps,
wherein six gears are provided by the following combinations:
first gear:low ratio and lower ratio;
second gear:low ratio and higher ratio;
third gear:intermediate ratio and lower ratio;
fourth gear:upper ratio and lower ratio;
fifth gear:intermediate ratio and higher ratio;
sixth gear:upper ratio and higher ratio.

86- A device according to claim 85, wherein the three-speed mechanism comprises an epicyclic train having:
a casing element;
an input rotary connection element;
an output rotary connection element;
a sun wheel;
a crown wheel;
a planet carrier connected to the output rotary connection element and supporting planets meshing with the sun wheel and with the crown wheel, and wherein
the low ratio is established by connecting the sun wheel for common rotation with the input rotary connection element and the crown wheel with the casing element;
the intermediate ratio is established by connecting the crown wheel for common rotation with the input rotary connection element and the sun wheel with the casing element;
the upper ratio is established by connecting the crown and the sun wheel for common rotation with the input rotary connection element.
